(19) United States
(12) Patent Application Publication
(10) Pub. No.: US 2016/0019226 A1
(43) Pub. Date: Jan. 21, 2016

(54) IDENTIFYING VIDEO FILES OF A VIDEO FILE STORAGE SYSTEM

(71) Applicant: Python4Fun, Inc., San Mateo, CA (US)

(72) Inventor: Devabhaktuni Srikrishna, San Francisco, CA (US)

(73) Assignee: PYTHON4FUN, INC., San Mateo, CA (US)

(21) Appl. No.: 14/852,510

(22) Filed: Sep. 12, 2015

Related U.S. Application Data
(63) Continuation-in-part of application No. 14/088,351, filed on Nov. 23, 2013, now Pat. No. 9,141,629.
Application No. 14/088,351 is a continuation of application No. 13/438,358, filed on Apr. 3, 2012, now Pat. No. 8,606,783.

(51) Int. Cl. G06F 17/30

(52) U.S. Cl. CPC G06F 17/3082; G06F 17/30389; G06F 17/3084; G06F 17/3053; G06F 17/30867

(57) ABSTRACT

Methods and systems for identifying one or more video files are disclosed. One method includes identifying a plurality of video files that have a relationship to a first search term, identifying a plurality of first files having a relationship to the first search term, generating a list of inquiries based on the plurality of identified video files, providing the list of inquiries to the at least one author of each of the plurality of first files, receiving one or more responses to the list of inquiries from at least one author of each of plurality of first files, and providing a video file from the list of video files that was selected by the most number of authors of the plurality of files to a user who has performed a search using a user search term that is related to the first search term.

This patent application is a continuation-in-part (CIP) of U.S. patent application Ser. No. 14/088,351, file Nov. 23, 2013, which is a continuation of U.S. patent application Ser. No. 13/438,358, filed Apr. 3, 2012, and Granted as U.S. Pat. No. 8,606,783 on Dec. 10, 2013, which are herein incorporated by reference.

### FIELD OF EMBODIMENTS

The described embodiments relate generally to search results. More particularly, the described embodiments relate to methods, and systems for identifying video files of a video file storage system.

### BACKGROUND

Search engines running on video file storage systems use a variety of search techniques to present individual videos or video files or files embedded with video to users based on one or more search terms that are provided by the users. The relevance of search results relate closely to the search terms, creators, or date created. The search engine generally produces a large number of results with videos that include some irrelevant results and are difficult to sort for relevant videos or video files. Many suggested videos are not relevant to the user. Relevant results are not always provided.

It is desirable to have methods and systems for identifying video files of a video file storage system.

### SUMMARY

One embodiment includes a method of identifying one or more video files. The method includes identifying a plurality of video files that have a relationship to a first search term, and identifying a plurality of first files having a relationship to a same, similar or related search term, wherein each of the first files has at least one author. For an embodiment, the relationship between the first search term and the plurality of first files includes at least one word of the first search term being included within at least one title of one of the plurality of first files. The method further includes generating a list of inquiries for the at least one author of each of the plurality of first files, allowing the at least one author to select video files from among at least one of the plurality of identified video files, providing the list of inquiries to the at least one author of each of the plurality of first files, receiving one or more responses to the list of inquiries from at least one author of each of plurality of first files, and providing a video file from the list of video files that was selected by the most number of authors of the plurality of files to a user who has performed a search using a user search term that is related to the first search term.

Another embodiment includes method of identifying video files. The method includes identifying a plurality of video files that have a relationship to a first search term, identifying a plurality of first files having a relationship to the first search term, wherein each of the first files has at least one author, generating a list of inquiries based on the identified plurality of video files, providing the list of inquiries to the at least one author of each of the first files, receiving one or more responses to the list of inquiries from at least one author of each of plurality of first files, re-ordering the list of video files based on responses to the list of inquiries, and providing the re-ordered list of video files to a user who has performed a search on the first search term.

Another embodiment includes a system for identifying video files. The system includes at least a server connected through a network to a plurality of user device that include displays. The is server configured to identify a plurality of video files that have a relationship to a first search term, and identifying a plurality of first files having a relationship to the first search term, wherein each of the first files has at least one author and wherein the relationship between the first search term and the plurality of first files includes at least one word of the first search term being included within at least one title of one of the plurality of first files, present on a first display a list of inquiries to an identified creator of a first file, wherein the list of inquiries is based on the plurality of video files, allowing the at least one author to select video files from among at least one of the plurality of identified video files, receive one or more responses to the list of inquiries from at least one author of each of plurality of first files the server configured to select a subset of the plurality of video files based on the at least one response, and present on a second display a video file from the list of video files that was selected by the most number of authors of the plurality of files to a user who has performed a search using a user search term that is related to the first search term.

Other aspects and advantages of the described embodiments will become apparent from the following detailed description, taken in conjunction with the accompanying drawings, illustrating by way of example the principles of the described embodiments.

### BRIEF DESCRIPTION OF DRAWINGS

In the following figures like reference numbers are used to refer to like elements. Although the following figures depict various examples, the one or more implementations are not limited to the examples depicted in the figures.

FIG. 1 is a block diagram of an embodiment of a system of selecting video files from a video file storage system, wherein at least one author of a plurality of first files provides input to selecting/ranking the video files, according to an embodiment.

FIG. 2 shows an example list of inquiries presented to the authors of the first files, according to an embodiment.

FIG. 3 is a block diagram of an embodiment of a system of selecting video files, wherein more than one authors of a plurality of first files provides input to selecting/ranking of the video files, according to an embodiment.

FIG. 4 is a flowchart that includes the steps of an example of a method of selecting video files in a video file storage system, wherein at least one author of a plurality of first files provides input to selecting/ranking the video files, according to an embodiment.

FIG. 5 is a flowchart that includes the steps of an example of a method of selecting video files in a video file storage system, wherein at least one author of a plurality of first files provides input to selecting/ranking the video files, according to another embodiment.

FIG. 6 shows an example of a block diagram of a system of providing related video files to a search result in a video file storage system.

### DETAILED DESCRIPTION

The described embodiments are embodied in methods, and systems for selecting video files to a user in a video file storage system, wherein at least one author of a plurality of first files provides input to selecting/ranking the video files, according to an embodiment. For at least some embodiments the plurality of video files is determined through, for example, a search using a first search term, or a term related to the first search term. For at least some embodiments, the plurality of first files is determined through, for example, another search using the same, a similar or related search term. At least one author is provided with a list of inquiries, wherein the inquiries include information of the plurality of video files. The plurality of video files are selected/ranked based on response received back from the at least one author to the list of inquiries.

The blocks of the block diagrams of the following embodiments can be implemented by one or more servers. Further, blocks (such as block 120) that are designated as a server, may be implemented as one or more servers performing the functions of the described embodiments.

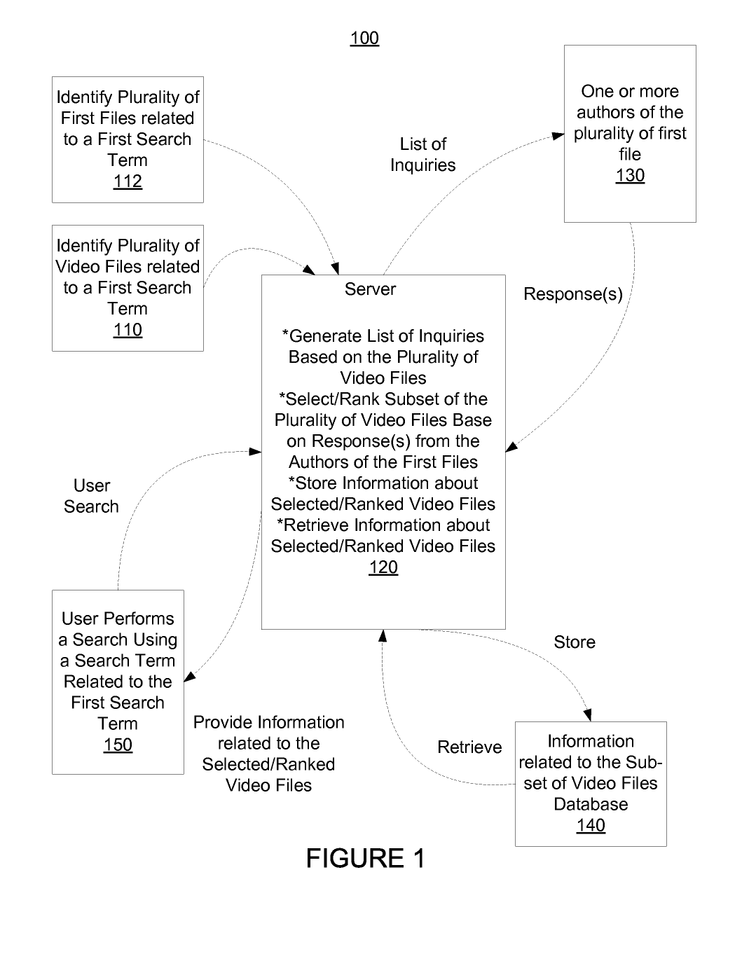

FIG. 1 is a block diagram of an embodiment of a system 100 of selecting video files from a video file storage system, wherein at least one author of a plurality of first files provides input to selecting/ranking the video files, according to an embodiment. For at least some of the described embodiments, video and video file may be interchanged to refer to a file in any video format or any type of file with embedded moving pictures or videos. For at least some embodiments, the video file storage system provides a platform for storing and sharing videos, and each video file includes a video and associated information. For at least one embodiment, the associated information includes at least metadata. Users can send video files and share the video files. In an embodiment, the shared video files have viewers or creators. Youtube®, Vimeo®, Hulu®, and Netflix® are all examples of video file storage systems, each storing video files or video streams addressable at hyperlinks on the World Wide Web. The video file storage system is accessible by the members of a group or users on the World Wide Web. In an embodiment, any user may edit a video file. In several embodiments, a first file is a text file of a disk drive of the user system, or a file on the internet, or a shared on a social network such as Twitter® or Facebook®, a file whose URL was shared by the user on a social network such as Twitter® or Facebook®, or a conversation or message on a social network, an email message or thread. It is to be understood that for various embodiments, the first file includes at least one of a web page, a document, an article, a social profile, a message, a message thread, a conversation, a video file, an audio file, or a picture file. It is also to be understood that this is not an exhaustive list.

The video file storage system is updated constantly as users add video files to the video file storage system. As the number of video files grows large, existence of the video file may not be known to many users if relevant hyperlinks to other video files are not created. Creating hyperlinks is a manual task and often few video files are hyperlinked together in a video file storage system. Search engines provide access to the video files that are not hyperlinked.

Unlike machine generated references using an algorithm running on a computer, the judgment of creators or authors of similar first files in selecting related video files is valuable to other readers due to the creator's or author's intrinsic understanding and motivation to identify materials related to the video file written by that creator. In general, an author or expert has greater interest and more precise understanding of the subject matter of what they wrote in their first file compared to other readers. In several embodiments, a creator may be any of author of one of the first files, a creator of one of a plurality of first files, a director, a narrator, a transcript creator, a sound technician, a music director, an expert on the subject matter or a team member, anyone who has write-privilege to the first file, or anyone who posts the file on a social network newsfeed.

When a search is performed, a set of video files may be presented by the search engine. For an embodiment, the video files are based on some criteria such as the number of hyperlinks a video file has, common subject matter, and the frequency of certain phrases in the meta-data or text-transcription of the video file. The number of hyperlinks is one of the criteria for search engines to list a video file at the top of the related video files. If a video file has no hyperlinks, the search engine may not list a video file at the top though the video file may be relevant. The criteria for suggesting a list of related video files can be improved by using an expert or creator to recommend the video files through hyperlinks. The process of semi-automating the presentation of a list of related video files is described in the embodiments.

For an embodiment, a set (plurality) of video files related to, for example, a first search term is identified in video file storage system 110 by server 120. In one embodiment, identifying in video file storage system 110 includes server 120 identifying a set (plurality) of video files related to the first search term and receiving the list of identified video files. For at least some embodiments, the relationship includes the set (plurality) of video files being video files that result due to a search using the first search term. For an embodiment, the relationship between the first search term and the plurality of videos includes at least one word of the first search term being included within at least one title of one of the plurality of first files.

However, for at least some embodiments, the relationship includes the set (plurality) of video files being video files that result due to a search using a second search term that is related to the first search term. For example, the second search term may include synonyms like kids and pediatric, or the second search term may include grammatical variations like children and child, etc.

In another embodiment, identifying in video file storage system 110 includes server 120 receiving the list (plurality) of identified video files.

In another embodiment, the set (plurality) of videos is a result of selection by a set (plurality) of human experts or creators who determine the relationship to the first search term.

In several embodiments, the set (plurality) of identified video files 110 can be the output of natural language search or text analysis on the meta-data or text-transcript of the video file, or from collaborative filtering, or any other search technique. In several embodiments, the search can be based on a string of words, or a picture or a creator. The set of video files is derived based on a relationship with the first search term. For at least some embodiments, the relationship includes the set (plurality) of video files being video files that result due to a search using the first search term. However, as previously mentioned, for at least some embodiments, the relationship includes the set (plurality) of video files being video files that result due to a search using a second search term that is related to the first search term. For example, the second search term may include synonyms like kids and pediatric, or the second search term may include grammatical variations like children and child, etc. For at least some embodiments, the relationship can be any one of or some of frequently used noun phrases in the meta-data or text-transcript of the video file, date created later than the first file, a specific date created, or a date created after a specific date. Video files published from a creator tend to have common subject matter. However, the occurrence of specific noun phrases in the video file storage system may change with technology or over a period of time. Many search engines may not have the intelligence to recognize the changing noun phrases over a period of time. In some embodiments, the full-text of the meta-data or transcript is used for searching to yield more relevant related video files. Video files with date created later than the first file are valuable as users are generally interested in recent updates.

Further, for an embodiment, a set (plurality) of first files related to, for example, a first search term (which can be the same search term used for the video files, a similar, or a related search term) is identified in file storage system 120 by server 120. In one embodiment, identifying in file storage system 112 includes server 120 identifying a set (plurality) of first files related to the first search term and receiving the list of identified first files. For at least some embodiments, the relationship includes the set (plurality) of first files being first files that result due to a search using the first search term. However, for at least some embodiments, the relationship includes the set (plurality) of first files being first files that result due to a search using a second search term that is related to the first search term. For example, the second search term may include synonyms like kids and pediatric, or the second search term may include grammatical variations like children and child, etc.

In another embodiment, identifying in video file storage system 112 includes server 120 receiving the list (plurality) of identified first files. In another embodiment, the set (plurality) of first files is a result of selection by a set (plurality) of human experts or creators who determine the relationship to the first search term. One embodiment includes identifying a plurality of first files having a relationship to the first search term, wherein each of the first files has at least one author, and wherein the relationship between the first search term and the plurality of first files includes at least one word of the first search term being included within at least one title of one of the plurality of first files.

In several embodiments, the set (plurality) of identified first files 112 can be the output of natural language search or text analysis on the meta-data or text-transcript of the first file, or from collaborative filtering, or any other search technique. In several embodiments, the search can be based on a string of words, or a picture or a creator. The set of first files is derived based on a relationship with the first search term. The relationship can be any one of or some of frequently used noun phrases in the meta-data or text-transcript of the video file, date created later than the first file, a specific date created, or a date created after a specific date. First files published from a creator tend to have common subject matter. Frequently used noun-phrases in the first file are also keywords for searching related first files. However, the occurrence of specific noun phrases in the file storage system may change with technology or over a period of time. Many search engines may not have the intelligence to recognize the changing noun phrases over a period of time. In some embodiments, the full-text of the meta-data or transcript is used for searching to yield more relevant related first files.

In an example, a search engine operating on server 120 uses the Google Data API to identify related video files in Youtube®, based on words in video file meta data and text-transcript of the video file. Youtube® is a free video file storage and transmission system. Google Data API® is a powerful application-programming interface that allows users to search for video files on Youtube®. In an example, a search engine operating on server 120 uses the Entrez API to identify related video files in PubMed®, based on words in first file meta data and text-transcript of the first file. PubMed® is a free first file storage and transmission system for published authors. Entrez API® is a powerful application-programming interface that allows users to search for first files on PubMed®.

Server 120 generates a list of inquiries based on the set (plurality) of video files related to the first search term. In an embodiment, the list of inquiries includes questions asking at least one author of the first files whether the video files are relevant to the first search term, and the search terms used in keyword search or noun-phrase used to select the video file. For at least some embodiments, the list of inquiries include the first search terms, or related text or term. For at least some embodiments, the list of inquiries includes information about the plurality of video files.

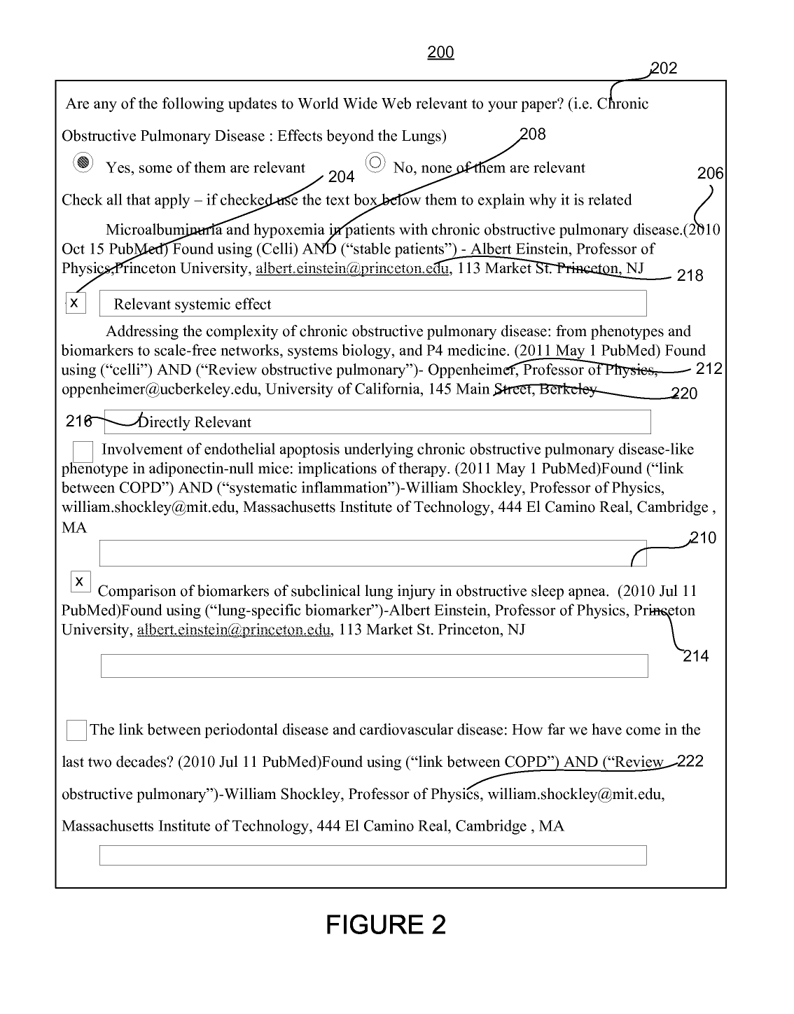

FIG. 2 shows example 200, an inquiry generated using keyword search by Google Data® API in Youtube®. For at least some embodiments, the list of inquiries includes information of the plurality of video files. For at least some embodiments, the list of inquiries is generated to allow at least one author of the plurality of first files to select video files from among at least one of the plurality of identified video files. Selection of keyword search results displays related video files. Example 200 shows the related video files from keyword searches. In example 200, 202 is the subject of the first file. The first question summarizes the inquiry about relevant video files. 204 is a check box next to a related video file selected by a search engine. 206 is the date created of the related video file. 208 is the first search term used to identify the related video file. 210 is an input box for the creator to enter the reason for the video file being relevant. 212 shows the author who selected the profile as relevant. 214 shows the institution of the author. 216 shows the relationship tag, 218 shows the email address of the author, 220 shows the address and 222 shows the affiliation of the author. In one embodiment, the identity of the senders who selected each message thread is revealed to the user by displaying meta-data such as the sender's name, address, or contact information.

For an embodiment, referring back to FIG. 1, one or more of the authors of the first files 130 is notified of the list of inquiries generated by server 120. In the described embodiments, the at least one author is the creator of at least one of the first files, an expert on the subject matter or a team member or anyone who has write-privilege to the first file. In the described embodiments, the notification can be sent electronically. In an embodiment, the notification email contains a hyperlink to a webpage that contains the list of inquiries. In another embodiment, the email contains the text of the inquiries. In another embodiment, the notification is sent by an email, or message on a social network such as Facebook® or Instant message system. In another embodiment, the notification is sent from a web-based interface such as Jive®, or LinkedIn® or Google Docs®. The at least one author completes the inquiry by selecting one or more video files related to the first search term in the opinion of the creator, and sends the response to the server using any of the notification methods described above. Server 120 receives the response to the inquiry from the at least one author and processes the response. For an embodiment, the response includes a selection of video files related to the first files. In an embodiment, the response includes a ranked list of the related video files.

When a user performs a search using a user search term related to the first search term (150), server 120 retrieves information about the selected/ranked related video files. For an embodiment, a video file from the list of video files that was selected by the most number of authors of the plurality of first files is provided to a user who has performed a search using a user search term that is related to the first search term. In an embodiment, video files selected by the at least one author are ranked higher than the video files not selected by the at least one author. For at least some embodiments, the video files are ranked according to the response(s) from the at least one author of the first files. In another embodiment, all video files selected by the at least one author 130 are selected. In another embodiment, a certain number of ranked video files are selected. For an embodiment, the server 120 creates a hyperlink between at least one of the first files and at least a subset of selected/ranked video files in the video file storage system. The hyperlink influences future search results of the engine when the first file or any of the subset of video files is involved. Server 120 stores information about the video files in a storage system 140 selected by the at least one author of the plurality of first files. The information includes one or more of hyperlinks to the related video files, ranking of the video files, the at least one author of the first files, and metadata of the video files. In the described embodiments, hyperlinks are references to video files that connect the users to another video/file or a portion of the video file. In another embodiment, storage system 140 is a separate storage system. In an embodiment, the user is presented with a list of information about the video files as shown in FIG. 2. In one embodiment, the identity of the at least one author who selected each video file is revealed to the user by displaying meta-data such as the creator's name, address, or contact information.

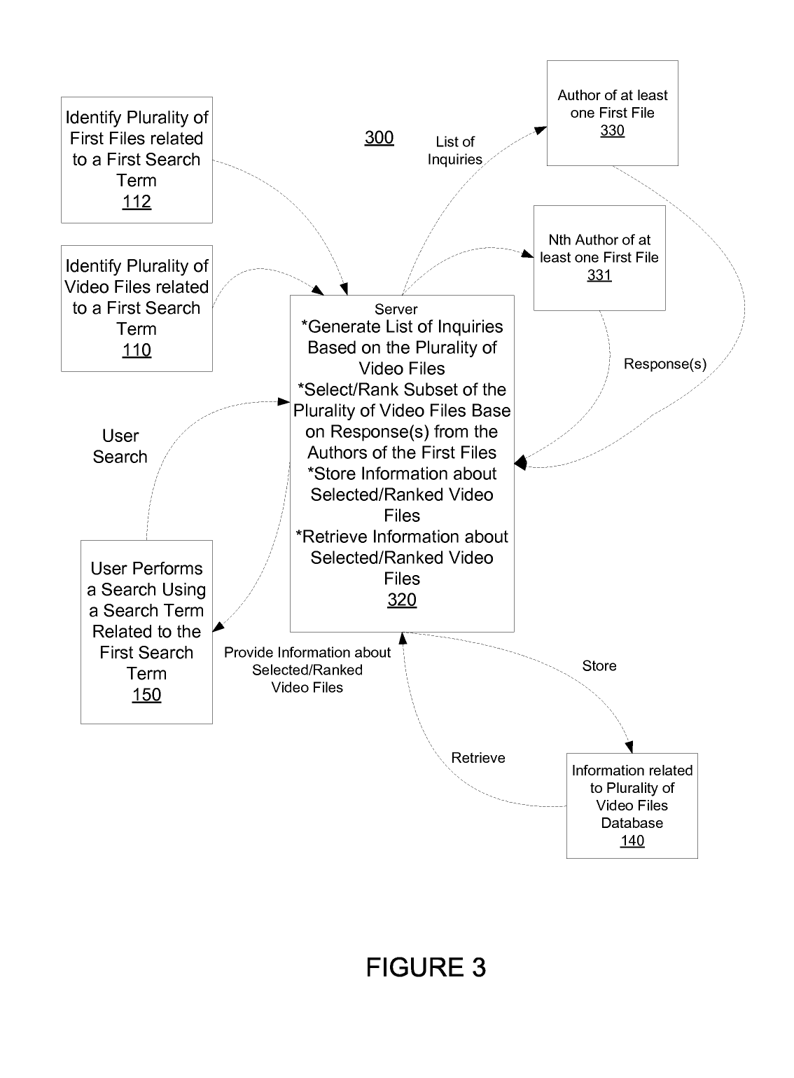

FIG. 3 is a block diagram of an embodiment of system 300, a system of selecting video files, where more than one author of the first files provides input to selecting/ranking of the video files. For an embodiment, the relationship between the first search term and the plurality of first files includes at least one word of the first search term being included within at least one title of one of the plurality of first files. A set (plurality) of video files related to the first search term is identified in video file storage system by server 320. The set (plurality) of video files is derived based on a relationship such as creator, frequently used noun-phrases, and common subject matter with the first search term. Server 320 generates a list of inquiries based on the set (plurality) of video files related to the first search term. In an embodiment, the list of inquiries includes questions asking the authors of the first files whether the related video files are relevant as determined by the search engine.

The list of inquiries generated by server 320 is notified to the first author 330. The list of inquiries is also notified to second (Nth) author 331. In the described embodiments, the second author is one or more authors other than the first author. The first and second authors are notified electronically as described in conjunction with FIG. 1. Server 320 receives responses from the first author as well as the second author. The response includes a selection of video files related to the first search term. In an embodiment, the response includes a ranked list of the related video files, identifying the relevance of the related video files to the first search term. In an embodiment, video files are ranked based on the number of selections from the first and the second author. In an embodiment, the video files selected by the first author are ranked higher than the video files selected by second author. In another embodiment, all responses are ranked with the same weight. In another embodiment, a certain number of ranked video files are selected. In another embodiment, all video files selected by the first author and the second author are selected.

Information about the selected/ranked video files is stored in a video file storage system 140. User performs a search relating to the first search term 150 which is sent to server 320. In an embodiment, server 320 retrieves information about the selected/ranked list of related video files from the video file storage system before presenting to the user. In one embodiment, the identity of the authors who selected each video file is revealed to the user by displaying meta-data such as the creator's name, address, or contact information.

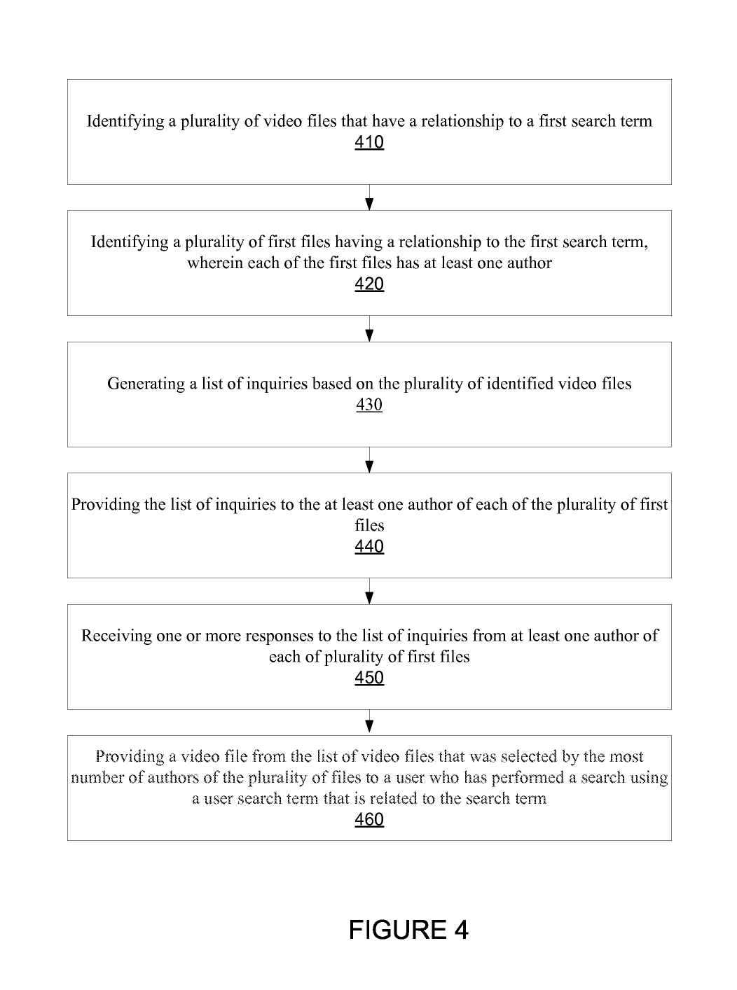

FIG. 4 is a flowchart that includes the steps of an example of a method of selecting video files in a video file storage system, wherein at least one author of a plurality of first files provides input to selecting/ranking the video files, according to an embodiment. A first step 410 includes identifying a plurality of video files that have a relationship to a first search term. For an embodiment, the relationship between the first search term and the plurality of video files includes at least one word of the first search term being included within at least one title of one of the plurality of video files. In step 410, for an embodiment, transcript or meta-data of the video files in the video file storage system is searched to identify one or more video files that are related to a first search term. In several embodiments, the search is based on any of or all of natural language search, machine language search, text analysis, or collaborative filtering. In an embodiment, the video file storage system is searched for keywords related to the first search term that are automatically generated by the server. The keywords may be the first search term, frequently appearing words, noun phrases based on subject matter, and subject. In an embodiment, the search is conducted on the full-text of the transcript or meta-data. In another embodiment, only the titles are searched. In embodiment, an algorithm used to generate the keywords using Google Data® API on Youtube® automatically extracts noun phrases from the first search term using natural language processing tools and ranks them by the number of occurrences in the video file meta-data compared to the number of occurrences on the video file storage system. In step 410, for an embodiment, the set (plurality) of videos is a result of selection by a set (plurality) of human experts or creators who determine the relationship to the first search term.

A second step 420 (which can occur either before or after the first step 410) includes identifying a plurality of first files having a relationship to the first search term, wherein each of the first files has at least one author. For an embodiment, the relationship between the first search term and the plurality of first files includes at least one word of the first search term being included within at least one title of one of the plurality of first files.

In step 420, for an embodiment, transcript or meta-data of the first files is searched to identify one or more first files that are related to the first search term (which may be the same, related or similar to the first search term used to select the video files). In several embodiments, the search is based on any of or all of natural language search, machine language search, text analysis, or collaborative filtering. In an embodiment, keywords are searched that are automatically generated by the server. The keywords may be the first search term, frequently appearing words, noun phrases based on subject matter, and subject. In an embodiment, the search is conducted on the full-text of the transcript or meta-data. In another embodiment, only the titles are searched. In embodiment, the algorithm used to generate the keywords using Google Data® API on Youtube® automatically extracts noun phrases from the first search term using natural language In step 420, for an embodiment, the set (plurality) of first files is a result of selection by a set (plurality) of human experts or creators who determine the relationship to the first search term. One embodiment includes identifying a plurality of first files having a relationship to the first search term, wherein each of the first files has at least one author, and wherein the relationship between the first search term and the plurality of first files includes at least one word of the first search term being included within at least one title of one of the plurality of first files.

A third step 430 includes generating a list of inquiries for at least one author of each of the plurality of first files based on the plurality of identified video files. For at least some embodiments, generating the list of inquiries allows the at least one author to select video files from among at least one of the plurality of identified video files.

A fourth step 440 includes providing the list of inquiries to the at least one author of each of the plurality of first files. A fifth step 450 includes receiving one or more responses to the list of inquiries from at least one author of each of plurality of first files. A sixth step 460 includes providing a video file from the list of video files that was selected by the most number of authors of the plurality of first files to a user who has performed a search using a ser search term that is related to the first search term.

At least some embodiments further include providing a ranking of the plurality of video files to the user, wherein the ranking is based on the one or more responses to the list of inquiries received from at least one author of each of plurality of first files.

For at least some embodiments, the relationship between the plurality of video files and the first search term comprises a first relationship, and the relationship between the plurality of first files and the first search term comprise a second relationship. For at least some embodiments, the first relationship and the second relationship are different. For at least some embodiments, the first relationship and the second relationship are the same.

For at least some embodiments, the relationship between the first search term and the plurality of video files includes one word of the first search term being included within at least one title of one of the plurality of video files. For at least some embodiments, the relationship between the first search term and the plurality of first files includes at least one word of the first search term being included within at least one title of one of the plurality of first files. For at least some embodiments, the relationship between the first search term and the plurality of video files includes the first search term being included within at least a title, metadata, or a transcript, of one of the plurality of video files.

For at least some embodiments, the list of inquiries includes one or more search terms used in a search that identified the plurality of video files. For at least some embodiments, the list of inquiries includes references to at least some of the plurality of video files.

For at least some embodiments, identifying the plurality of video files that have the relationship to the first search term comprises receiving search results of a third party. That is, a third party, such as, Youtube® generates the plurality of video files based on a search term related to the first search term. For an embodiment, the video file systems of the described embodiments receives the search results and selects or ranks the plurality of video files based on the responses of the authors of the first files to the list of inquiries. For an embodiment, the set (plurality) of video files is a result of selection by a set (plurality) of human experts or creators who determine the relationship to the first search term.

For at least some embodiments, identifying the plurality of first files that have a relationship to the first search term comprises receiving search results of a third party. Further, the plurality of search files may be received from a third party, such as, Google® that performed the search and established the relationship between the plurality of first files and the first search term. For an embodiment, the set (plurality) of first files is a result of selection by a set (plurality) of human experts or creators who determine the relationship to the first search term.

One or more authors of the first files are then sent inquiries related to the video files, wherein the responses to the inquiries are used to select and or rank video files from the plurality of video files.

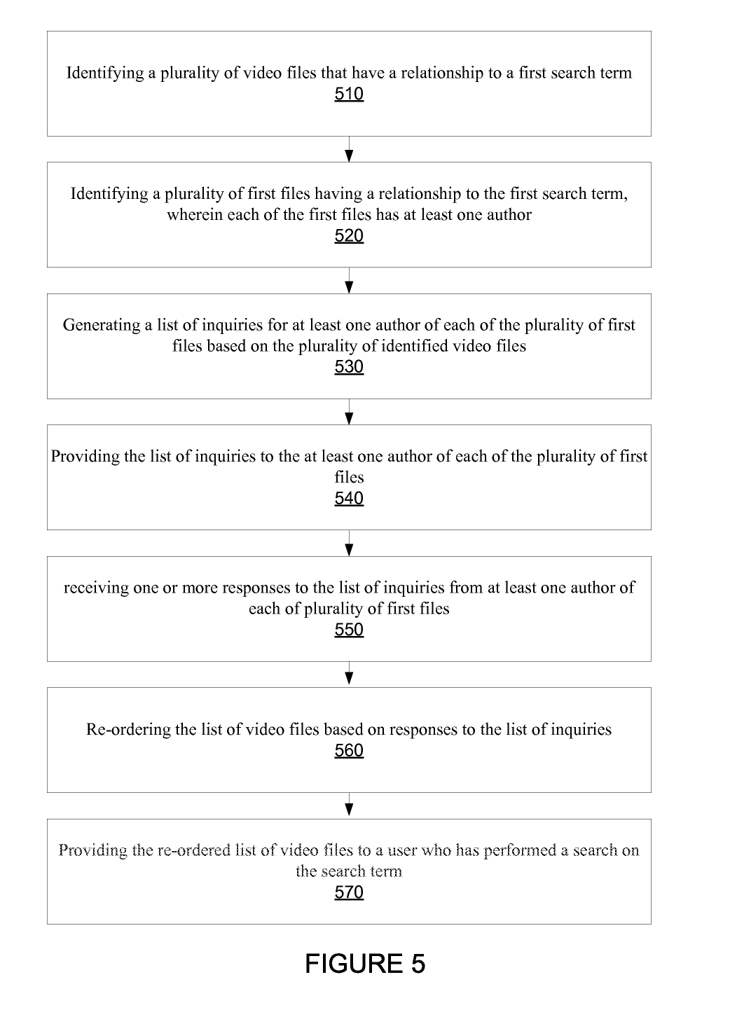

FIG. 5 is a flowchart that includes the steps of an example of a method of selecting video files in a video file storage system, wherein at least one author of a plurality of first files provides input to selecting/ranking the video files, according to another embodiment. A first step 510 includes identifying a plurality of video files that have a relationship to a first search term. For an embodiment, the relationship between the first search term and the plurality of first files includes at least one word of the first search term being included within at least one title of one of the plurality of first files. For an embodiment, the video file systems of the described embodiments receives the search results and selects or ranks the plurality of video files based on the responses of the authors of the first files to the list of inquiries. For an embodiment, the set (plurality) of video files is a result of selection by a set (plurality) of human experts or creators who determine the relationship to the first search term.

A second step 520 includes identifying a plurality of first files having a relationship to the first search term, wherein each of the first files has at least one author. For an embodiment, the set (plurality) of first files is a result of selection by a set (plurality) of human experts or creators who determine the relationship to the first search term.

A third step 530 includes generating a list of inquiries based on the identified plurality of video files. A fourth step 540 includes providing the list of inquiries to the at least one author of each of the first files. A fifth step 550 includes receiving one or more responses to the list of inquiries from at least one author of each of plurality of first files. A sixth step 560 includes re-ordering the list of video files based on responses to the list of inquiries. A seventh step 570 includes providing the re-ordered list of video files to a user who has performed a search on the first search term.

For at least some embodiments, re-ordering the list of video files includes ranking the plurality of video files, wherein the ranking is based on the one or more responses to the list of inquiries received from at least one author of each of plurality of first files.

For at least some embodiments, a plurality of authors respond to the list of inquiries, and wherein a weight of a response from one author on the ranking is greater than a weight of a response from another author on the ranking. For at least some embodiments, the weight of the response from the one author is proportional to the number of first files associated with the one author.

For at least some embodiments, the relationship between the plurality of video files and the first search term comprises a first relationship, and the relationship between the plurality of first files and the first search term comprise a second relationship. For at least some embodiments, the first relationship and the second relationship are different. For at least some embodiments, the first relationship and the second relationship is the same.

For at least some embodiments, the relationship between the first search term and the plurality of video files includes one word of the first search term being included within at least a title, metadata, or a transcript, of each of the plurality of video files. For at least some embodiments, the list of inquiries includes one or more search terms used in a search that identified the plurality of video files. For at least some embodiments, the list of inquiries includes references to at least some of the plurality of video files.

### Generation of List of Inquiries

In an embodiment, the list of inquiries generated by the system server includes one or more identified video files related to a first search term. In an embodiment, the inquiries include the first search terms used in a search using text analysis or collaborative filtering. In another embodiment, the list of inquires includes one or more identified video files and the noun-phrases from the first search term(s) used to identify the video files. In an embodiment, the list of inquiries presented to the at least one author of the first files includes one or more subjects of related video files, the first search term used to identify the related video files, the noun-phrases which are validated by their presence in the hyperlinks from the first file, the date created, the abstract and the unique identification. In an embodiment, a questionnaire is generated authors of the identified first files. The questionnaire may contain questions whether the identified video file(s) is related to the first search term or one or more of the first files. The list of inquires is notified electronically to one or more authors of the first files. The notification comprises at least one of an email, messaging on a social network, instant video or a web-based interface notification.

### Selection and Ranking of Related Video Files

For an embodiment the video files related to the first search term are ranked based on the number of selections from the authors of the first files. For an embodiment, a video file from the list of video files that was selected by the most number of authors of the plurality of first files is provided to a user who has performed a search using a user search term that is related to the first search term. In an embodiment, a selection of the related video file from each author is ranked equally. In another embodiment, selection of a video file from the authors of the first files receives higher ranking. In another embodiment, selection of a video file from a creator who responds to queries more often is ranked higher. In another embodiment, selection by the author of at least one first file of the identified first files is ranked higher. In another embodiment, selection of a video file by the author of at least one first file of the identified first files and creator of the video file is ranked highest. In an embodiment, all video files selected by the authors of the identified first files are selected. In another embodiment, a certain number of the ranked video files are selected. In another embodiment, video files receiving a certain rank are selected.

For at least some embodiments, identifying the at least one author includes providing the user with the at least one creator's name, qualifications, institution, affiliation, address, or contact information. An embodiment of a method further comprising providing, by the system server, the selected plurality of video files to a user that selects the first file and identifying the at least one author of the first file(s), and the at least one creator of the plurality of video files to the user, wherein identifying the at least one author or the at least one creator comprises providing the user with the at one of a name, qualifications, institution, affiliation, address, or contact information of the at least one author or at least one creator.

For at least some embodiments, the plurality of video files are each identified by a plurality of search term searches, wherein each search identifies one of the plurality of video files, and a search using the same, related or similar search term identifies the plurality of first files. At least some embodiments include a method wherein at least one of the plurality of video object searches is refined by the at least one response. At least some embodiments include a method wherein at least one of the plurality of video object searches uses a keyword search application programming interface to access video files in the video file storage system. At least some embodiments include a method wherein the list of inquiries includes search terms used in a search (or searches) that identified the first files and the plurality of video files, thereby establishing a relationship between the first files and the plurality of video files by text analysis or collaborative filtering. An embodiment of a method wherein the first search terms comprise strings of words. At least some embodiments include a method wherein the first search terms comprise noun phrases. An embodiment of a method wherein the first search terms comprise creator names cited by the first file. An embodiment of a method wherein the first search terms comprise a term within the first file. An embodiment of a method the search is based on at least one of a word string, a creator, or an image. An embodiment of a method wherein the first search terms are included within text of citations of the first file.

For at least some embodiments, receiving from the at least one author at least one response to the list of inquiries includes receiving a ranked list of at least a subset of the plurality of video files that identifies an order of relevance of the at least the subset of the plurality of video files to the first file. An embodiment of a method further comprising providing the at least one inquiry based on one response to at least one other author; receiving from the at least one other author at least one second response to the at least one response; re-selecting the subset of the plurality of video files based on the at least one second response; storing information related to the re-selected subset of the plurality of video files for access if the first file is selected. An embodiment of a method wherein the list of inquiries is provided to a plurality of authors, and responses received from each of the plurality of authors are compiled for selecting the subset of the plurality of video files. An embodiment of a method wherein a plurality of lists of inquiries are provided to a plurality of authors, and responses received from each of the plurality of authors are compiled for selecting the subset of the plurality of video files. An embodiment of a method further comprising the at least one author having a permission to edit the first file. An embodiment of a method for a server to identify video files having relevance to a first files, comprising receiving, by the server, a plurality of video files, wherein the plurality of video files were generated by a subject matter search; generating, by the server, a list of inquiries based on the plurality of video files; providing, by the server, the list of inquiries to an author of the first file, wherein the first file is a one of the plurality of video files; receiving, by the server, from the author at least one response to the list of inquiries; selecting, by the server, a subset of the plurality of video files based on the at least one response; storing, by the server, the selected subset of the plurality of video files for access if the first file is selected.

At least some embodiments include providing, by the server, the selected plurality of video files to a user that searches videos using the first search term. For at least some embodiments, a server is configured to present on a first display a list of inquiries to at least one identified author of at least one of the first files, wherein the list of inquiries is based on a plurality of video files; the server configured to receive from the identified author at least one response to the list of inquiries; the server configured to select/rank the plurality of video files based on the at least one response; a server configured to present on a second display the selected/ranked plurality of video files to a user that searches video files using the first search term. An embodiment of a programmable storage device readable by a machine, tangibly embodying a program of instructions when executed by the machine to perform a method of identifying video files of a video file storage system having relevance to a first search term.

### System

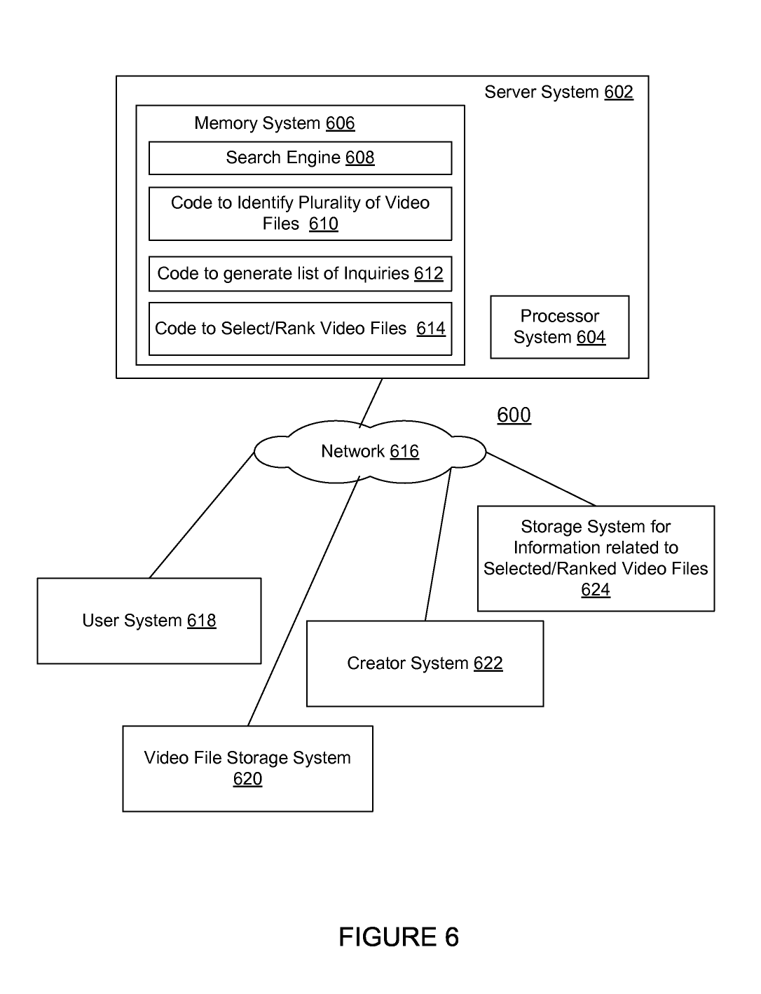

FIG. 6 shows a block diagram of system 600, an embodiment of a system of providing related video files to a search result. The system consists of server system 602, network 616, user system 618, video file storage system 620, creator system 622, and storage system for information related to selected/ranked subset of video files 624 among others. In other embodiments, system 600 may not have all of the elements or features listed and/or may have other elements or features instead of or in addition to those listed.

As shown in FIG. 6, for the described embodiments, server system 602 includes processor system 604 and memory system 606 among others. Server system 602 consists of one or more servers connected to the network. Server system 602 can be a single unit, distributed in various locations, or virtualized. Processor system 604 may include any one of, some of, any combination of, or all of multiple parallel processors, a single processor, a system of processors having one or more central processors and/or one or more specialized processors dedicated to specific tasks. Also, processor system 604 may include one or more Digital Signal Processors (DSPs) in addition to or in place of one or more Central Processing Units (CPUs) and/or may have one or more digital signal processing programs that run on one or more CPU.

Memory system 606 may include, for example, any one of, some of, any combination of, or all of a long-term storage system, such as a hard drive; a short-term storage system, such as random access memory; a removable storage system, such as a floppy drive or a removable drive; and/or flash memory. Memory system 606 may include one or more machine-readable mediums that may store a variety of different types of information. The term machine-readable medium is used to refer to any medium capable carrying information that is readable by a machine. One example of a machine-readable medium is a computer-readable medium.

In an embodiment, memory system 606 stores code for search engine 608, code to identify plurality of video files 610, code to generate a list of inquiries/questionnaire 612, and code to select/rank the video files 614. Memory system 606 stores code for the search engine 606 to search the video file storage system for video files related to a first search term and to search for first files related to the first search term, and returns the results to server system 602. In the described embodiments, the first files can reside in the video file storage system 620, or creator system 622, or storage system for information related to selected/ranked subset of video files 624 or memory system 606 or any other storage system. In an embodiment, the search engine searches the abstract of the transcript or the title of the transcript. In another embodiment, the search engine searches the entire transcript for keywords. The results from the search engine are ranked in order of relevancy. The relevancy may be the number of times the keyword appears in the transcript, and the number of hyperlinks.

The keywords for searching related video files or first files are supplied by the code to identify plurality of video files 610. The keywords may be all of or some of frequently used noun phrases, the creator of the first file, the creators listed in the references cited in the first file, words from the title, date created, words related to subject matter. Once the server receives the list (plurality) of video files related to the first search term, and the list (plurality) of first files, an inquiry is automatically generated by code to generate a list of inquiries 612 and sent to one or more authors of the first files. For an embodiment, the list of inquiries is based on the search results. For at least some embodiments, the inquiries include the relevancy of each of video files listed as a related video file to the first files, the reason for the video file being related to the first search term. Code to select/rank video files 614, stores information about the selected/ranked video files. Selection of video files may also include ranking the video files based on the number of selection from the authors of the first files. In an embodiment, responses from different authors can have different weight. Information related to the selected/ranked video files is stored. In an embodiment, the information related to the selected/ranked subset of video files is stored on a storage system for information related to selected/ranked subset of video files 624. In another embodiment, the information related to the selected/ranked subset of video files is stored in memory system 606. In another embodiment, the information related to the selected/ranked subset of video files is stored in the video file storage system. In an embodiment, a hyperlink is created between the first file and the selected subset of video files. The hyperlink influences the ranking of search results by the search engine when the first file is involved.

Network 616 is a network and/or combination of networks of devices that communicate with one another within an enterprise or on the Internet. User system 618 is a user device connected to the network 616. User system 618 selects a video file from the video file storage system. The video file is selected from a search result or from a listing of video files. Video file storage system 620 is a shared storage system. All users can access the video file storage system to read and in some cases contribute to the video file storage system. Creator system 622 is a user system in the network. The creator system has read/write access to video files in the video file storage system. A creator of a video file may be a producer of the video file, the director of the video file, the transcript creator, the narrator, co-creator of the file, an expert in the subject matter or a team member.

An embodiment includes a programmable storage device (such as memory system 606) readable by a machine (such as, processor system 604), tangibly embodying a program of non-transitory instructions when executed by the machine to perform a method of identifying files of a collaborative file storage system. One method includes identifying a plurality of video files that have a relationship to a first search term, identifying a plurality of first files having a relationship to the first search term, wherein each of the first files has at least one author, and wherein the relationship between the first search term and the plurality of first files includes at least one word of the first search term being included within at least one title of one of the plurality of first files, generating a list of inquiries for the at least one author of each of the plurality of first files, allowing the at least one author to select video files from among at least one of the plurality of identified video files, providing the list of inquiries to the at least one author of each of the plurality of first files, receiving one or more responses to the list of inquiries from at least one author of each of plurality of first files, and providing a video file from the list of video files that was selected by the most number of authors of the plurality of first files to a user who has performed a search using a user search term that is related to the first search term.

Although specific embodiments have been described and illustrated, the described embodiments are not to be limited to the specific forms or arrangements of parts so described and illustrated.

What is claimed:

1. A method of identifying video files, comprising:
identifying a plurality of video files that have a relationship to a first search term;
identifying a plurality of first files having a relationship to the first search term, wherein each of the first files has at least one author;
generating a list of inquiries for the at least one author of each of the plurality of first files, allowing the at least one author to select video files from among at least one of the plurality of identified video files;
providing the list of inquiries to the at least one author of each of the plurality of first files;
receiving one or more responses to the list of inquiries from at least one author of each of plurality of first files; and
providing a video file from the list of video files that was selected by the most number of authors of the plurality of files to a user who has performed a search using a user search term that is related to the first search term.

2. The method of claim 1, further comprising providing a ranking of the plurality of video files to the user, wherein the ranking is based on the one or more responses to the list of inquiries received from at least one author of each of plurality of first files.

3. The method of claim 1, wherein the relationship between the first search term and the plurality of first files includes at least one word of the first search term being included within at least one title of one of the plurality of first files.

4. The method of claim 1, wherein the relationship between the first search term and the plurality of video files includes at least one word of the first search term being included within at least one title of one of the plurality of video files.

5. The method of claim 1, wherein the relationship between the plurality of video files and the first search term comprises a first relationship, and the relationship between the plurality of first files and the first search term comprise a second relationship.

6. The method of claim 5, wherein the first relationship and the second relationship are different.

7. The method of claim 1, wherein the relationship between the first search term and the plurality of video files includes the first search term being included within at least one title of one of the plurality of video files.

8. The method of claim 1, wherein the relationship between the first search term and the plurality of video files includes the first search term being included within at least a title, metadata, or a transcript, of one of the plurality of video files.

9. The method of claim 1, wherein the list of inquiries includes one or more search terms used in a search that identified the plurality of video files.

10. The method of claim 1, wherein the list of inquiries includes references to at least some of the plurality of video files.

11. The method of claim 1, wherein identifying the plurality of video files that have the relationship to the first search term comprises receiving search results of a third party.

12. The method of claim 1, wherein identifying the plurality of first files that have a relationship to the first search term comprises receiving search results of a third party.

13. A method of identifying video files, comprising:
identifying a plurality of video files that have a relationship to a first search term;
identifying a plurality of first files having a relationship to the first search term, wherein each of the first files has at least one author;
generating a list of inquiries based on the identified plurality of video files;
providing the list of inquiries to the at least one author of each of the first files;
receiving one or more responses to the list of inquiries from at least one author of each of plurality of first files;
re-ordering the list of video files based on responses to the list of inquiries; and
providing the re-ordered list of video files to a user who has performed a search on the first search term.

14. The method of claim 13, wherein re-ordering the list of video files includes ranking the plurality of video files, wherein the ranking is based on the one or more responses to the list of inquiries received from at least one author of each of plurality of first files.

15. The method of claim 14, wherein a plurality of authors respond to the list of inquiries, and wherein a weight of a response from one author on the ranking is greater than a weight of a response from another author on the ranking.

16. The method of claim 15, the weight of the response from the one author is proportional to the number of first files associated with the one author.

17. The method of claim 13, wherein the relationship between the plurality of video files and the first search term comprises a first relationship, and the relationship between the plurality of first files and the first search term comprise a second relationship.

18. The method of claim 17, wherein the first relationship and the second relationship are different.

19. The method of claim 13, wherein the relationship between the first search term and the plurality of video files includes the first search term being included within at least a title, metadata, or a transcript, of each of the plurality of video files.

20. The method of claim 13, wherein the list of inquiries includes one or more search terms used in a search that identified the plurality of video files.

21. The method of claim 13, wherein the list of inquiries includes references to at least some of the plurality of video files.

22. A system for identifying video files, comprising:
a server connected through a network to a plurality of user device that include displays;
the server configured to:
identify a plurality of video files that have a relationship to a first search term, and identifying a plurality of first files having a relationship to the first search term, wherein each of the first files has at least one author and wherein the relationship between the first search term and the plurality of first files includes at least one word of the first search term being included within at least one title of one of the plurality of first files;
present on a first display a list of inquiries to an identified creator of a first file, wherein the list of inquiries is based on the plurality of video files, allowing the at least one author to select video files from among at least one of the plurality of identified video files;
receive one or more responses to the list of inquiries from at least one author of each of plurality of first files the server configured to select a subset of the plurality of video files based on the at least one response; and
present on a second display a video file from the list of video files that was selected by the most number of authors of the plurality of files to a user who has performed a search using a user search term that is related to the first search term.

23. A system for identifying video files, comprising:
a server connected through a network to a plurality of user device that include displays;
the server configured to:
identify a plurality of video files that have a relationship to a first search term, and identifying a plurality of first files having a relationship to the first search term, wherein each of the first files has at least one author;
present on a first display a list of inquiries to an identified creator of a first file, wherein the list of inquiries is based on the plurality of video files;
receive one or more responses to the list of inquiries from at least one author of each of plurality of first files the server configured to select a subset of the plurality of video files based on the at least one response;
re-order the list of video files based on responses to the list of inquiries; and
present on a second display the re-ordered list of video files to a user who has performed a search on the first search term.
